(19) United States
(12) Patent Application Publication
(10) Pub. No.: US 2007/0102893 A1
(43) Pub. Date: May 10, 2007

(54) COMPUTER CADDY

(76) Inventor: Randall Mayo, Cave Creek, AZ (US)

Correspondence Address: SCHMEISER OLSEN & WATTS, 18 E UNIVERSITY DRIVE, SUITE # 101, MESA, AZ, 85201, US

(21) Appl. No.: 11/556,540

(22) Filed: Nov. 3, 2006

Related U.S. Application Data
(60) Provisional application No. 60/734,609, filed on Nov. 7, 2005.

(51) Int. Cl. B62B 3/10

(52) U.S. Cl. 280/79.11

(57) ABSTRACT

A computer caddy includes a base with a handle, two side panels, a rear shelf, retainer plates, and casters or other slidable components. A computer tower may be placed on the base between the side panels. The rear shelf is used to support a power strip and retainer plates function to keep the power strip on the shelf. Cable couplers allow a user to organize the cables extending from the back of the computer onto the computer caddy by use of apertures for receiving the cable couplers. The casters provide mobility to the computer caddy, and the handle allows the user to easily move the computer caddy

### BACKGROUND OF THE INVENTION

1. Technical Field

This invention relates generally to a computer support system and more particularly to a moveable computer support system.

2. State of the Art

The use of computers is continually increasing not only in business, but also in homes of consumers. Typical computers include a computer tower which retains the central processing unit (CPU), the motherboard, the hard drive, peripheral drives, and other components necessary for a computer to function properly. These towers are typically stored either on a desk or more commonly on the floor of the business or home under a desk. A majority of the cables used to lead to the monitor, keyboard, mouse or other external accessories of a computer are located on the back of the tower. Because the computer tower is typically on the floor, gaining access to the back of the computer tower to adjust cables, to replace current accessories with a new one, to add further accessories, to perform maintenance and to clean around the computer tower is difficult and inconvenient. This becomes even more inconvenient when these types of activities take place in a business where there are several computers that need to be accessed. Additionally, the cables extending from the back of the computer often tangle with each other and create a visual mess and further difficulty in performing any type of maintenance on the computer.

Conventional computer supports have a support base and casters to provide simply for the ability to move the computer tower more easily. However, they are lacking in a proper support base to support every type of tower, and additionally they have a greater tendency to tip or fall during movement due to the narrow base and/or wheel base supporting the computer. Further they do not provide for management and/or organization of the computer cables. Additionally, conventional computer supports are lacking in the ability to support and retain a power strip and do not provide a support or device to retain computer accessories and/or computer peripherals. Further still, conventional computer supports are lacking a handle to aid in the moving of the computer support.

Accordingly, there is a need in the field of computer support systems for an improved moveable computer support system.

### DISCLOSURE OF THE INVENTION

The present invention relates to a moveable computer caddy or computer support system for supporting a computer tower.

An aspect of the present invention includes a computer caddy comprising a base plate with a handle, two side panels coupled on opposing side edges of the base, a rear brace bar coupled between the side panels, a rear shelf comprising a retainer plate, and computer cable couplers attached to rear portions of the base, the side panels and the retainer plate.

Another aspect of the present invention includes a computer caddy comprising a base plate with a handle, two side panels coupled on opposing side edges of the base, wherein the side panels have attachment members, and at least one accessory support coupled to at least one side panel by use of the attachment members.

Further still, another aspect of the present invention includes a computer caddy comprising a base plate with a handle, two side panels coupled on opposing side edges of the base, wherein the side panels have attachment members, at least one accessory support coupled to at least one side panel by use of the attachment members, a rear brace bar coupled between the side panels, a rear shelf comprising a retainer plate and computer cable couplers.

Another aspect of the present invention includes a computer caddy for supporting and retaining a computer tower, the computer caddy comprising a base plate having a handle and two side panels rotatably coupled to opposing sides of the base plate. The two side panels being rotatable to provide access to the computer tower. The computer caddy further includes a rear shelf adapted to retain a power strip.

Still another aspect of the present invention includes a computer organizing system comprising a computer tower having a plurality of cables for connecting and operating a plurality of components of the computer tower and a computer caddy supporting and retaining the computer tower. The computer caddy includes a base plate for supporting the computer tower, a rear shelf for supporting and retaining a power strip, and cable couplers coupled to apertures of the computer caddy. The cable couplers are adapted to organize and couple the cables of the computer tower to the computer caddy.

Yet still, another aspect of the present invention includes a method of using a computer caddy, the method comprising steps of receiving a computer tower within the computer caddy, connecting cables to the computer tower, and organizing the cables by use of cable couplers coupled to apertures of the computer caddy.

The foregoing and other features and advantages of the present invention will be apparent from the following more detailed description of the particular embodiments of the invention, as illustrated in the accompanying drawings.

### BRIEF DESCRIPTION OF THE DRAWINGS

FIG. 1 is a perspective view of a computer caddy, in accordance with the present invention;

FIG. 2A is a side view of a side panel of a computer caddy, in accordance with the present invention;

FIG. 2B is a side view of a side panel coupled to a base plate of a computer caddy, in accordance with the present invention;

FIG. 2C is a perspective view of a computer caddy with a rotated side panel, in accordance with the present invention;

FIGS. 3A is a perspective view of a computer caddy with a computer tower supported by the computer caddy, in accordance with the present invention;

FIGS. 3B is a rear view of a computer caddy with a computer tower supported by the computer caddy, in accordance with the present invention;

FIGS. 3C is a front view of a computer caddy with a computer tower supported by the computer caddy, in accordance with the present invention;

FIG. 4 is an exploded perspective view of a computer caddy, in accordance with the present invention;

FIG. 5 is a top view of a computer caddy, in accordance with the present invention;

FIG. 6A is a perspective view of an accessory support, in accordance with the present invention;

FIG. 6B is a side view of an accessory support, in accordance with the present invention; and

FIG. 6C is a front view of an accessory support, in accordance with the present invention.

### DETAILED DESCRIPTION OF EMBODIMENTS OF THE INVENTION

As discussed above, embodiments of the present invention relate to a moveable computer caddy or computer support system for supporting a computer tower. Generally a computer caddy in accordance with embodiments of the present invention includes a base with a handle and side panels.

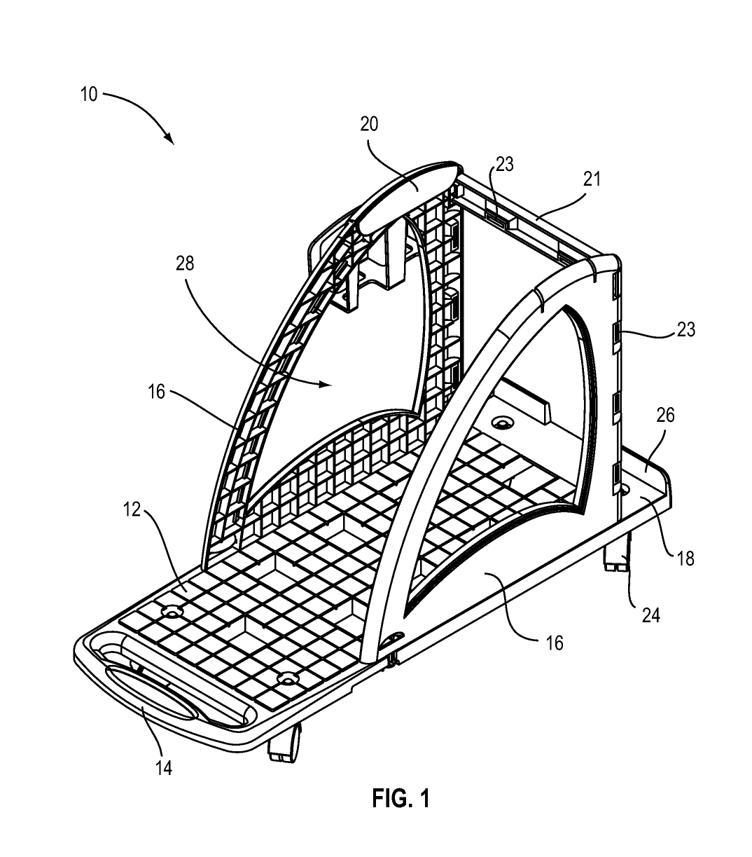

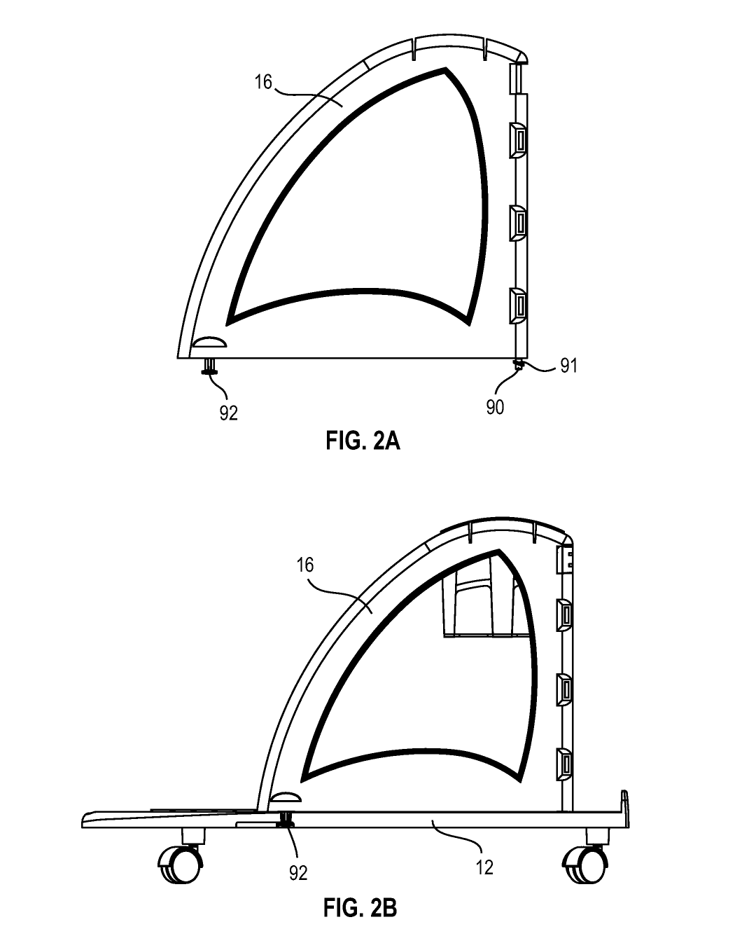

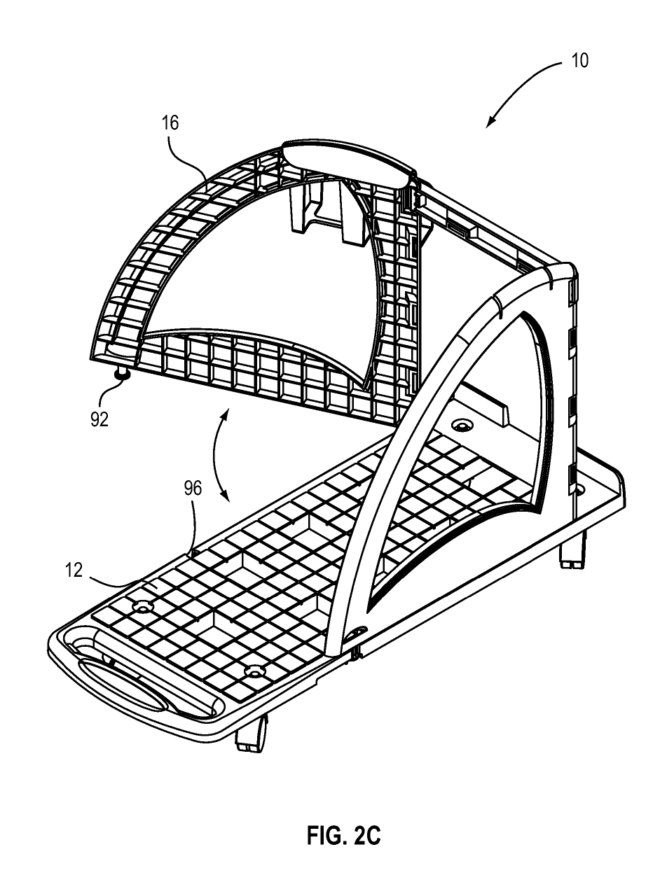

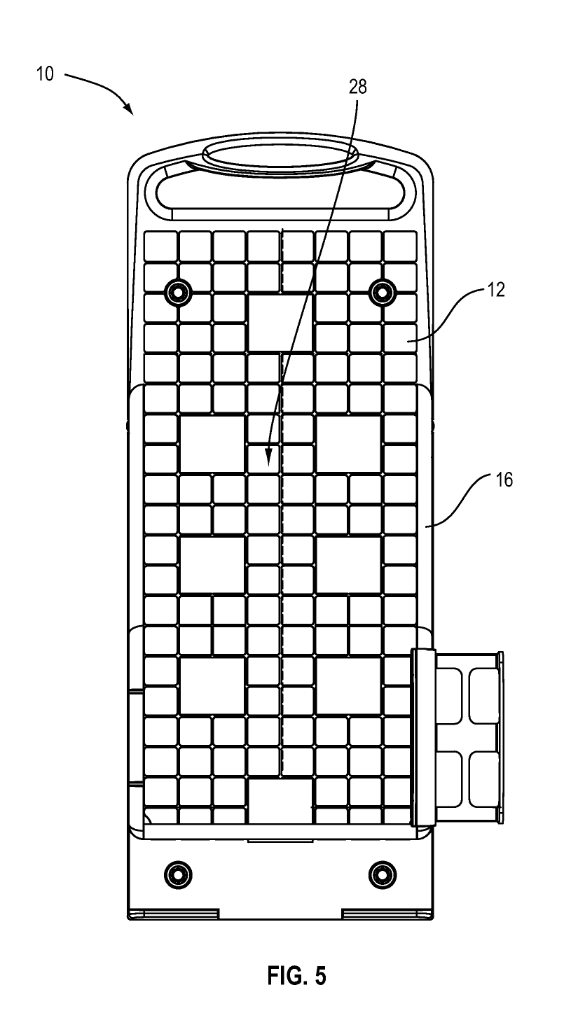

As shown in FIG. 1, particular embodiments of the present invention comprise a computer caddy 10. The computer caddy 10 may comprise a base 12 with handle 14, side panels 16, a rear shelf 18 and casters 24. The computer caddy may also comprise an accessory support 20, crossbeam 21 and apertures 23 for receiving cable couplers. The base 12 may be in a substantially horizontal position so as to provide proper support to a computer tower retained within the computer caddy 10. The handle 14 of the base is configured to provide access to the handle 14 when a computer tower is being supported by the computer caddy 10. A user can use the handle 14 to move the computer caddy 10 to gain access to the back of the computer tower or simply to just clean around the tower. Referring also to FIGS. 2A, 2B and 5, the side panels 16 may be coupled to opposing sides of the base 12, wherein the side panels 16 are coupled in a substantially perpendicular direction from the base 12, such that the side panels 16 extend up from the base 12 and create a tower space 28. The tower space 28 may be dimensioned to receive a computer tower, wherein the size and dimension of the computer tower may vary so long as the dimensions are smaller than the dimensions of the tower space 28. The side panels 16 provide additional support to a computer tower placed within the computer caddy, and may be of any shape and form so long as it provides the necessary support to the computer tower to prevent tipping of the computer tower.

In particular embodiments, a rear shelf 18 is operatively coupled to the base 12 of the computer caddy 10. The rear shelf 18 may be aligned with the base 12 such that a top portion of the shelf 18 and the base 12 are substantially horizontal and within the same plane. The shelf 18 may comprise at least one retainer plate 26. The retainer plate 26 is configured to retain a particular object on the shelf 18, particularly when the computer caddy 10 is moved using the casters 24. A fastener strap, such as a hook and loop fastener strap, may be used to further retain a particular object on the shelf 18. Additionally, the cable couplers received in apertures 23 may be used to retain computer cables in an orderly fashion creating a cleaner area and providing more efficient access to the cables of the computer. The cable couplers may be coupled to apertures 23 along a rear edge of the side panels 16 and the crossbeam 21. It will be understood that the shelf 18 while shown to be in the same plane as the base, may be located anywhere and further, may be located on a rear portion of the caddy 10. Further, the apertures 23 may also be located in a plurality of locations to receive various types of cable couplers, such as, but not limited to flexibly rigid fingers, straps, hook and loop fasteners, clips, tie downs, and any other component wherein a portion of the cables are retained on the computer caddy 10.

The accessory support 20 is removably coupled to an upper portion of a side panel 16 and configured to receive and retain an external computer accessory. Such accessories may include an external hard drive, disk drive, digital camera, digital camcorder, modem, and many other accessories that are not internal to the computer tower. The accessory support 20 is not limited to being located on an upper portion, but may be located anywhere on a side panel. Further, the accessory support 20 may be removably coupled to either side panel and in particular embodiments, two accessory supports 20 may be used on the computer caddy 10.

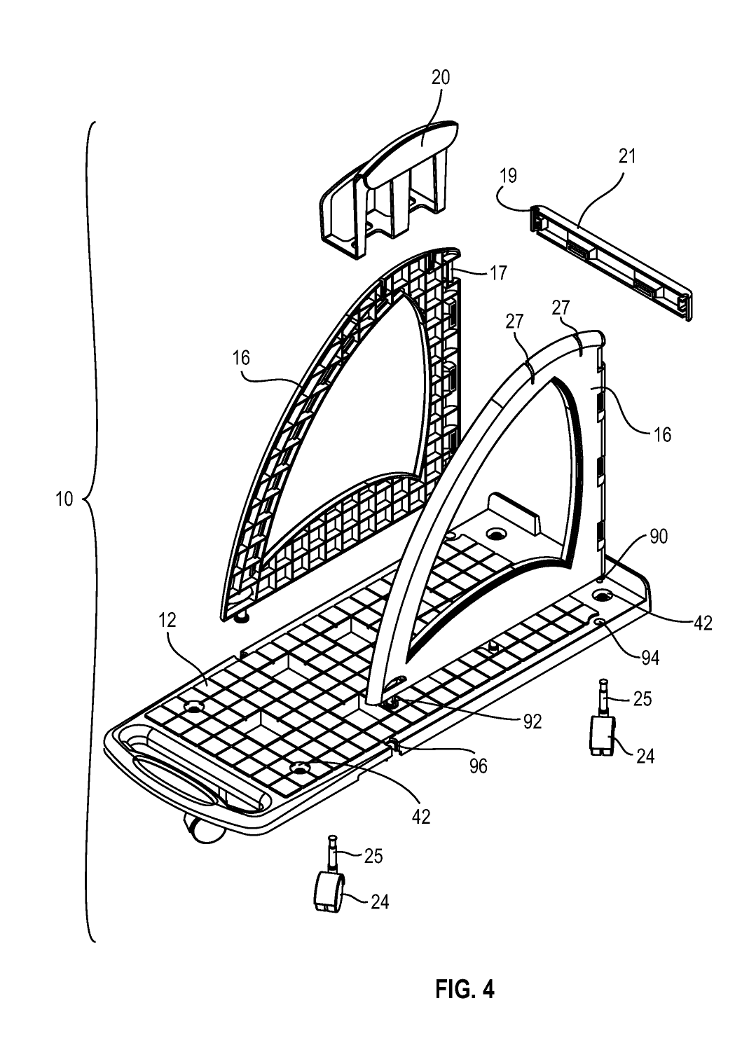

Referring again to the drawings, FIGS. 2A-2C depicts a side panel 16 and the coupling of the side panel 16 to a base plate 12 of a computer caddy 10 in accordance with particular embodiments of the present invention. The side panel 16 comprises a first protrusion 90 and a second protrusion 92 extending from a bottom edge of the side panel 16. The first protrusion 90 is pivotably coupled to the base plate 12 by use of aperture 94 and the second protrusion is releasably secured to the base plate 12 within slot 96, shown in FIGS. 2C and 4. The side panels 16 are rotatable about the first protrusion 90 when the second protrusion 92 is released from slot 96 of the base plate 12. In particular embodiments, the first protrusion 90 includes threads 91, wherein the threads 91 engage corresponding threads of the aperture 94 when the side panel 16 is coupled to the base plate 12. The threads 91 allow the side panel 16 to rotate while securing the first protrusion 90 within the aperture 94. It will be understood that the side panels 16 may be coupled to the base plate 12 in various different ways, so long as the side panels are rotatable to provide access to the computer tower.

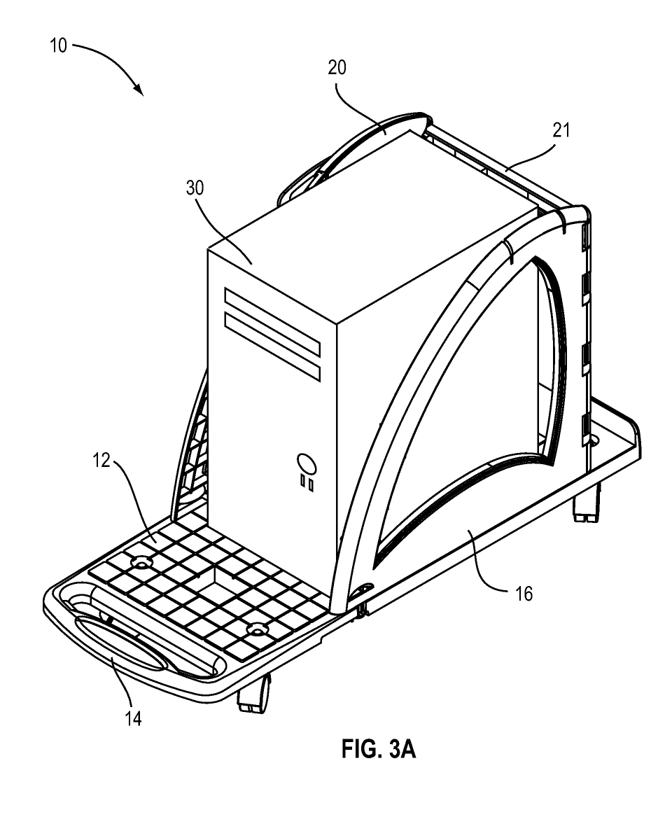

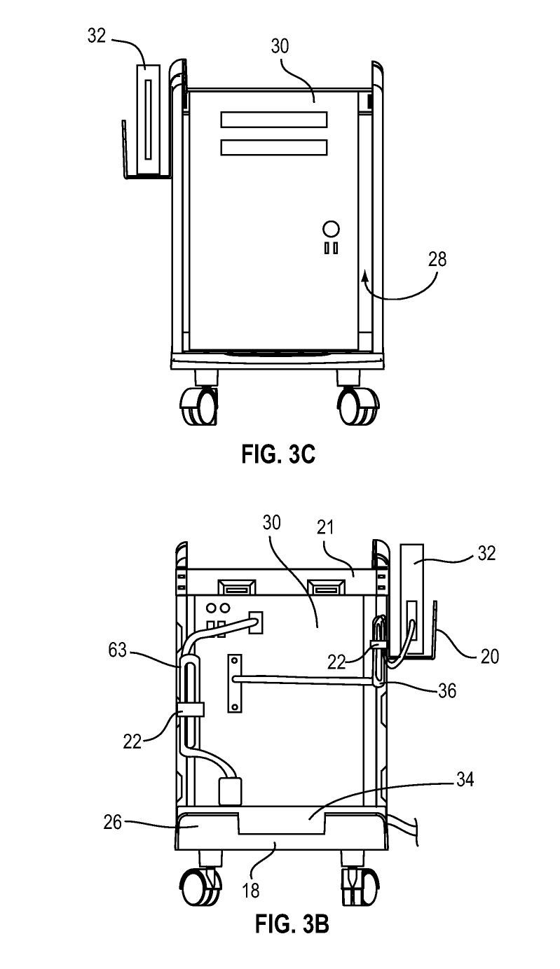

Referring further to the drawings, FIGS. 3A-3C depicts a computer caddy 10 supporting and retaining a computer tower 30. The tower 30 fits within the tower passageway 28, supported by the base 12 and between the side panels 16. The side panels 16 and the crossbeam 21 provide added support to prevent tipping of the tower 30 during movement of the caddy 10. The handle 14 may then be used to move the computer caddy 10 and the tower 30. This is particularly useful when needing to access the back portion of the computer tower as seen in FIG. 3B, wherein the caddy 10 can be easily moved exposing the cables and the back of the tower 30 for maintenance and/or connecting additional devices to the computer. Further the accessory support 20 may be used to retain accessory 32 and provide easy access to the back of the tower 30 for connecting accessory 32 to the computer. Cable couplers 22 are then used to retain and organize computer cables 22. The shelf 18 may support a power strip 34 with multiple outlets and the retainer plates 26 may further support and retain the power strip 34 on the shelf 18, particularly during movement of the caddy 10. In such particular embodiments, the caddy 10 lifts the computer tower off of the floor. This provides added protection to the computer, particularly in office situations wherein the office has a sprinkler fire system. Computer towers are often stored under desks. The desk typically protects the computer from being damaged by the water from on top if the sprinkler fire system is activated, however, the tower 30 is subject to damage and water collects on the floor of the office and contacts the computer tower 30 as water runs under the desk. The computer caddy 10 supports the computer tower 30 above the ground surface, as well as all cables and power sources, thereby preventing water damage from water collection on the floor. Additionally, the ability to easily move the computer caddy 10 with the computer tower 30 on it, allows for easier, more efficient cleaning of spaces under desks and behind the tower 30.

Looking at the drawings further, FIG. 4 depicts an exploded view of a computer caddy 10. In particular embodiments of the present invention, the side panels 16 may be coupled to the base 12 by use of first and second protrusions 90, 92 coupled to aperture 94 and slot 96 respectively. Caster apertures 42 are configured to receive shafts 25 of the casters 24. The casters 24 are thereby coupled to a bottom side of the base plate 12 and the casters 24 are rotatable in all directions for moving the computer caddy 10 while the computer caddy 10 retains the computer tower. The crossbeam 21 may be coupled to a rear edge of the side panels 16 by use of shaft 17 of each of the side panels mating with corresponding channels 19 of the crossbeam 21. The channels 19 and the shafts 17 are coupled together by a press fit, however, other methods of coupling may be employed, including, but not limited to, clips, clamps, snaps, straps, and the like. The accessory support 20 may be coupled to either side panel 16 by use of slots 27. Slots 27 correspond to protrusions (not shown) of the accessory support 20.

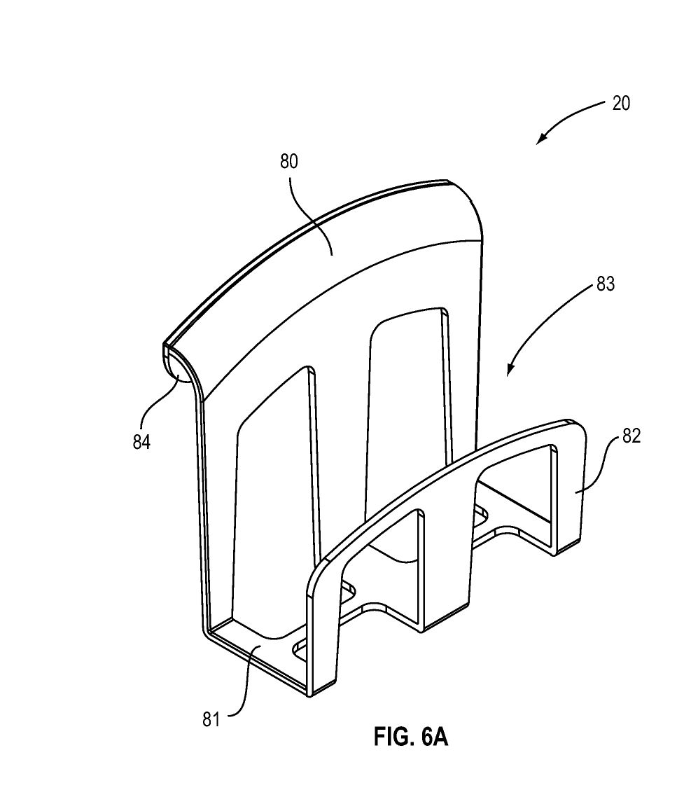

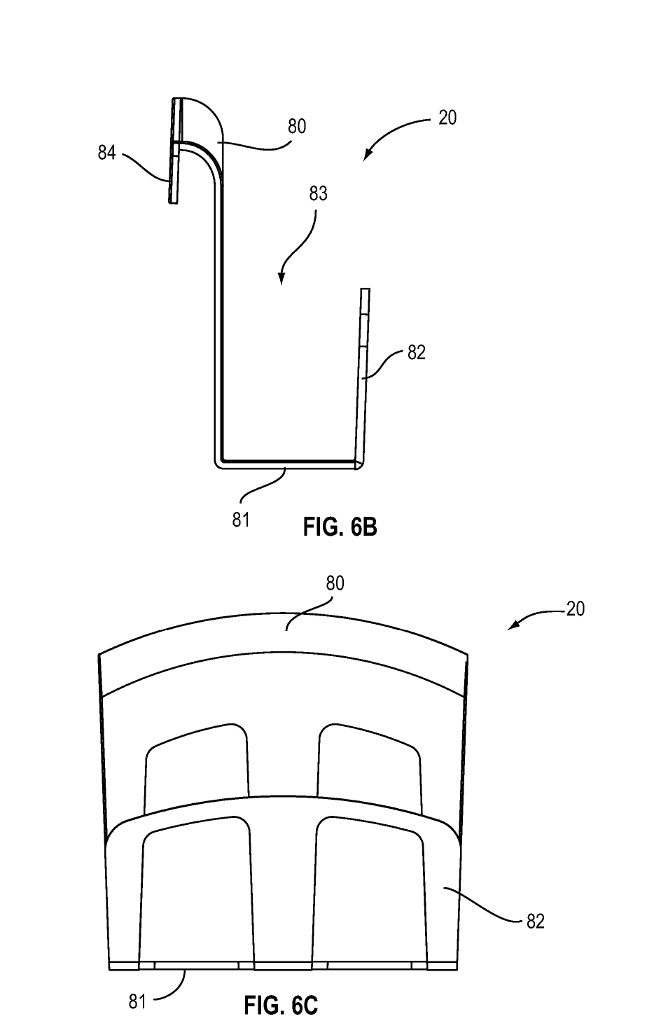

Referring again the drawings, FIGS. 6A-6C depict an accessory support 20 in accordance with particular embodiments of the present invention. The accessory support 20 comprises a support base 81 with a first side portion 80 and a second side portion 82 coupled to opposing edges of the base 81. The side portions extend upward and outward from the base 81 creating and accessory space 83. The accessory space 83 may be dimensioned to receive various types of computer accessories and/or peripherals. The accessory support 20 further comprises an accessory support flange 84. The flange 84 is configured to removably couple to a slot 27 of a side panel 16 of a computer caddy 10. This coupling of the accessory support 20 to the caddy 10 has sufficient strength to support various types of computer accessories and/or peripherals. It will be understood that each side panel has slots 27 so as to allow coupling of the accessory support 20 onto either side panel 16, or to have two accessory supports 20 coupled to each side panel 16. It will be understood that the accessory support 20 may be coupled to the side panel 16 in any way and is not limited to this particular embodiment. For example, and without limitation, the accessory support may be coupled to the side panel by a notch and hook, a nut and bolt, a hook and loop fastener, a rivet, a weld, an epoxy, an adhesive, and any other form of coupling the accessory support 20 to the side panel. It will also be understood that the accessory support 20 may be integral to the side panel 16.

Another particular embodiment of the present invention includes base that may comprise a handle, a shelf and retaining plates, wherein the base, handle, shelf and retaining plates are integral with each other such that they form one single component. The base may also comprise side panel recesses, wherein the side panel recesses are configured to receive protrusions that extend from the side panel (not shown) and are used to couple the side panels to the base. Further, base apertures are also located on the base to lighten the weight of the material as well as provide for better ventilation and cooling of a computer tower supported by the base.

It will be understood by those of ordinary skill in the art that while particular embodiments couple the side panel to the base, other particular embodiments may include a computer caddy that is formed as a single unit wherein all of the components including the base, side panels, crossbeam, handle, shelf retaining plates and cable couplers are all integral with each other.

It will be understood by those of ordinary skill in the art that the retaining plates 26 may be coupled to the rear shelf 18 by various ways of attaching the retainer plate 26 to the shelf 18 that include, but are not limited to, a press fit, a threaded fit, a clip, an epoxy, a weld, a bolt and any other form of coupling a retainer plate 26 to the shelf 18. Further, the rear shelf 18 and the retaining plates 26 may be integral with each other.

According to another particular embodiment, the present invention includes a computer caddy comprising a base, side panels and a slide rails. The slide rails are used in place of the casters and are used in other particular embodiments wherein the slide rails allow the caddy to be easily slid and moved on the floor surface, thereby providing access to the back of a computer tower. It will be understood that mobility of computer caddies according to particular embodiments of the present invention are not limited to casters and slide rails, but that any manner of providing mobility while lifting a base of the caddy off of a floor surface may be use. For example, and without limitation, mobility may be accomplished by using: two casters coupled to a rear portion of the caddy and at least one support foot coupled to a front portion of the caddy such that the front of the caddy may be lifted using the handle and the caddy moved using the two casters, such that when the foot is placed on the floor surface, it supports the computer caddy and provides resistance to unwanted movement of the caddy; and at least three support feet with slidable bottom surface, wherein the slidable surfaces easily slide on the floor surface allowing movement of the caddy. Additionally, other ways of providing mobility of the caddy may include without limitation ski shaped rails and a toboggan shaped support under the base plate. Further, the components that provide mobility of the caddy may be attached to the computer caddy by one of coupling to the computer caddy, integral to the computer caddy and any combination thereof.

The components defining any particular embodiment of a computer caddy may be formed of any of many different types of materials or combinations thereof that can readily be formed into shaped objects provided that the components selected are consistent with the intended operation of a computer caddy. For example, the components may be formed of: rubbers (synthetic and/or natural) and/or other like materials; glasses (such as fiberglass) carbon-fiber, aramid-fiber, any combination thereof, and/or other like materials; polymers such as thermoplastics (such as ABS, Fluoropolymers, Polyacetal, Polyamide; Polycarbonate, Polyethylene, Polysulfone, and/or the like), thermosets (such as Epoxy, Phenolic Resin, Polyimide, Polyurethane, Silicone, and/or the like), any combination thereof, and/or other like materials; composites and/or other like materials; metals, such as zinc, magnesium, titanium, copper, iron, steel, carbon steel, alloy steel, tool steel, stainless steel, aluminum, any combination thereof, and/or other like materials; alloys, such as aluminum alloy, titanium alloy, magnesium alloy, copper alloy, any combination thereof, and/or other like materials; any other suitable material; and/or any combination thereof.

Furthermore, the components defining any particular embodiment of the present invention may be purchased pre-manufactured or manufactured separately and then assembled together. However, any or all of the components may be manufactured simultaneously and integrally joined with one another. Manufacture of these components separately or simultaneously may involve extrusion, pultrusion, vacuum forming, injection molding, blow molding, resin transfer molding, casting, forging, cold rolling, milling, drilling, reaming, turning, grinding, stamping, cutting, bending, welding, soldering, hardening, riveting, punching, plating, and/or the like. If any of the components are manufactured separately, they may then be coupled with one another in any manner, such as with adhesive, a weld, a fastener (e.g. a bolt, a nut, a screw, a nail, a rivet, a pin, and/or the like), wiring, any combination thereof, and/or the like for example, depending on, among other considerations, the particular material forming the components. Other possible steps might include sand blasting, polishing, powder coating, zinc plating, anodizing, hard anodizing, and/or painting the components for example.

Another aspect of the present invention includes a method of using a computer caddy, the method comprising steps of receiving a computer tower within the computer caddy, connecting computer cables to the computer tower, and organizing the cables by use of cable couplers coupled to apertures of the computer caddy. The method may further comprise a step of moving the computer caddy by use of the handle to provide access to the back of the computer tower and/or to clean behind the computer tower. The method may also include the steps of attaching an accessory support onto a side panel, placing a computer accessory and/or a peripheral in the accessory support, connecting the accessory operatively to the computer tower by use of a cable and organizing the cable by use of the cable couplers

The embodiments and examples set forth herein were presented in order to best explain the present invention and its practical application and to thereby enable those of ordinary skill in the art to make and use the invention. However, those of ordinary skill in the art will recognize that the foregoing description and examples have been presented for the purposes of illustration and example only. The description as set forth is not intended to be exhaustive or to limit the invention to the precise form disclosed. Many modifications and variations are possible in light of the teachings above without departing from the spirit and scope of the invention.

1. A computer caddy for supporting and retaining a computer tower, the computer caddy comprising:
a base plate having a handle;
two side panels rotatably coupled to opposing sides of the base plate, the two side panels being rotatable to provide access to the computer tower; and
a rear shelf adapted to retain a power strip.

2. The computer caddy of claim 1, further comprising a rear brace bar coupled between the two side panels.

3. The computer caddy of claim 1, further comprising apertures for receiving cable couplers, the cable couplers adapted to couple and organize cables of the computer tower.

4. The computer caddy of claim 1, further comprising at least one accessory support adapted to removably couple to one of the side panels.

5. The computer caddy of claim 1, further comprising casters coupled to a bottom side of the base plate, the casters being rotatable in all directions for moving the computer caddy while the computer caddy retains the computer tower.

6. The computer caddy of claim 1, wherein the rear shelf further includes a retainer plate to retain the power strip on the rear shelf.

7. The computer caddy of claim 1, wherein the side panels each include a first and second protrusion, the first protrusion pivotably coupled to the base plate and the second protrusion releasably secured to the base plate, wherein the side panels are rotatable about the first protrusion when the second protrusion is released from the base plate.

8. A computer organizing system comprising:
a computer tower having a plurality of cables for connecting and operating a plurality of components of the computer tower; and
a computer caddy supporting and retaining the computer tower; the computer caddy including:
a base plate for supporting the computer tower;
a rear shelf for supporting and retaining a power strip; and
cable couplers coupled to apertures of the computer caddy, the cable couplers adapted to organize and couple the cables of the computer tower to the computer caddy.

9. The system of claim 8, wherein the computer caddy further comprises two side panels rotatably coupled to opposing sides of the base plate, the two side panels being rotatable to provide access to the computer tower.

10. The system of claim 9, wherein the side panels each include a first and second protrusion, the first protrusion pivotably coupled to the base plate and the second protrusion releasably secured to the base plate, wherein the side panels are rotatable about the first protrusion when the second protrusion is released from the base plate

11. The system of claim 9, wherein the computer caddy further comprises a rear brace bar coupled between the two side panels.

12. The system of claim 9, wherein the computer caddy further comprises at least one accessory support adapted to removably couple to one of the side panels.

13. The system of claim 8, wherein the computer caddy further comprises casters coupled to a bottom side of the base plate, the casters being rotatable in all directions for moving the computer caddy while the computer caddy retains the computer tower.

14. The system of claim 8, wherein the rear shelf of the computer caddy further includes a retainer plate to retain the power strip on the rear shelf.

15. A method of using a computer caddy, the method comprising steps of:
receiving a computer tower within the computer caddy;
connecting cables to the computer tower; and
organizing the cables by use of cable couplers coupled to apertures of the computer caddy.

16. The method of claim 15, further comprising a step of moving the computer caddy by use of a handle of the computer caddy to provide access to the back of the computer tower.

17. The method of claim 15, further comprising steps of attaching an accessory support to the computer caddy; and
receiving and retaining a computer accessory within the accessory support.

18. The method of claim 17, further comprising steps of operatively connecting the computer accessory to the computer tower by use of a cable; and
organizing the cable by use of the cable couplers.
